(19) United States
(12) Patent Application Publication
(10) Pub. No.: US 2007/0165410 A1
(43) Pub. Date: Jul. 19, 2007

(54) Sectored lights

(76) Inventor: John Peter Rochfort, Paramata (NZ)

Correspondence Address: Ronald R Santucci;Frommer Lawrence and Haug, 745 Fifth Avenue, New York, NY, 10151, US

(21) Appl. No.: 10/571,440

(22) PCT Filed: Sep. 16, 2004
(86) PCT No.: PCT/NZ04/00217

§ 371 Date: Nov. 20, 2006

(30) Foreign Application Priority Data
Sep. 16, 2003 (NZ) 528259

(51) Int. Cl. F21V 5/00

(52) U.S. Cl. 362/328; 362/477; 362/245; 362/276

(57) ABSTRACT

A sectored light primarily for use in the marine industry incorporating LED's as a light source. The light includes a novel light dispensing lens (16) in conjunction with positively curved (convex) reflective elements (15) to provide a superior “arc of visibility” with low light scatter and sharp cut off transition.

This invention relates to sectored lights and aids to navigation, and in particular, although not exclusively, for application to the marine industry.

### BACKGROUND

The use of sectored (navigation) lights by vessels under way at sea during the hours of darkness is mandatory under the International Regulations for Preventing Collisions at Sea. Such vessels include recreational pleasure crafts of a size larger than a regulated minimum length; commercial powered vessels such as fishing boats, barges, tugs and larger commercial powered vessels such as freighters; and also a range of unpowered vessels (usually commercial in nature) such as barges either under tow or anchored at rest.

As a minimum, the lights include red and green sidelights to port and starboard sides respectively, and a white stern light. Vessels with masts carry a white light on the mast (two in the case of larger boats). Their “arcs of visibility” are strictly laid down so that it is possible to judge the course of the vessel at night by studying the streaming lights which are visible to an observer.

Various types of vessel require different combinations of lights, however, almost all require use of the red and green sidelights. The red and green sidelights are sometimes combined into a single unit.

The present invention primarily relates to these sectored lights.

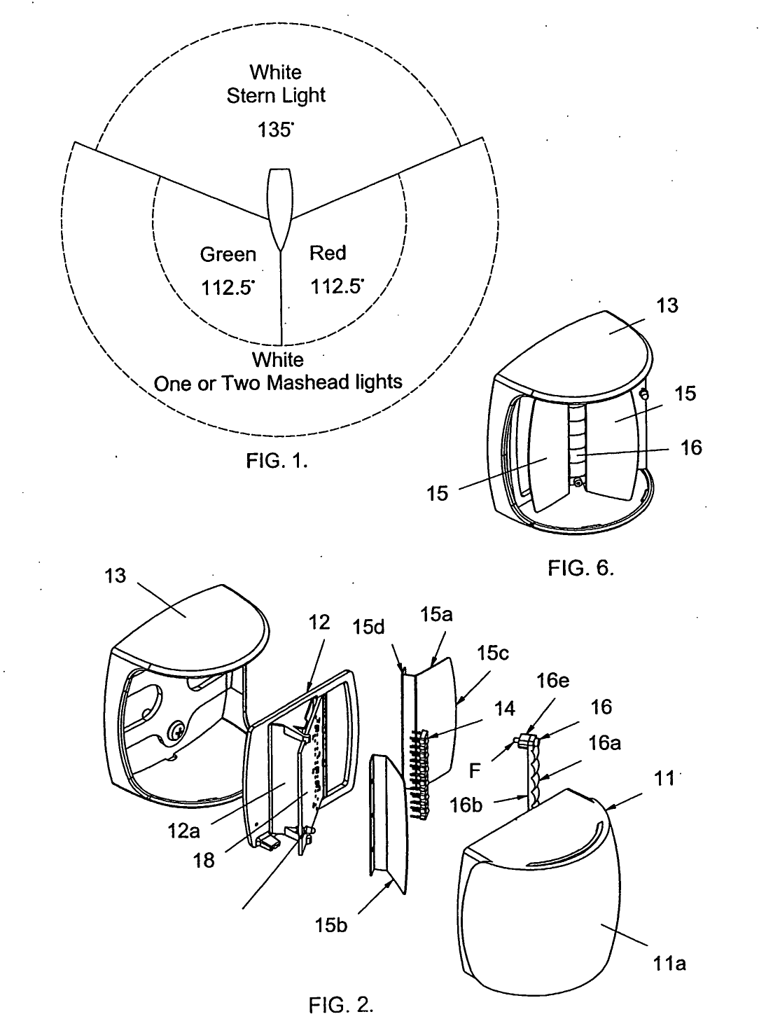

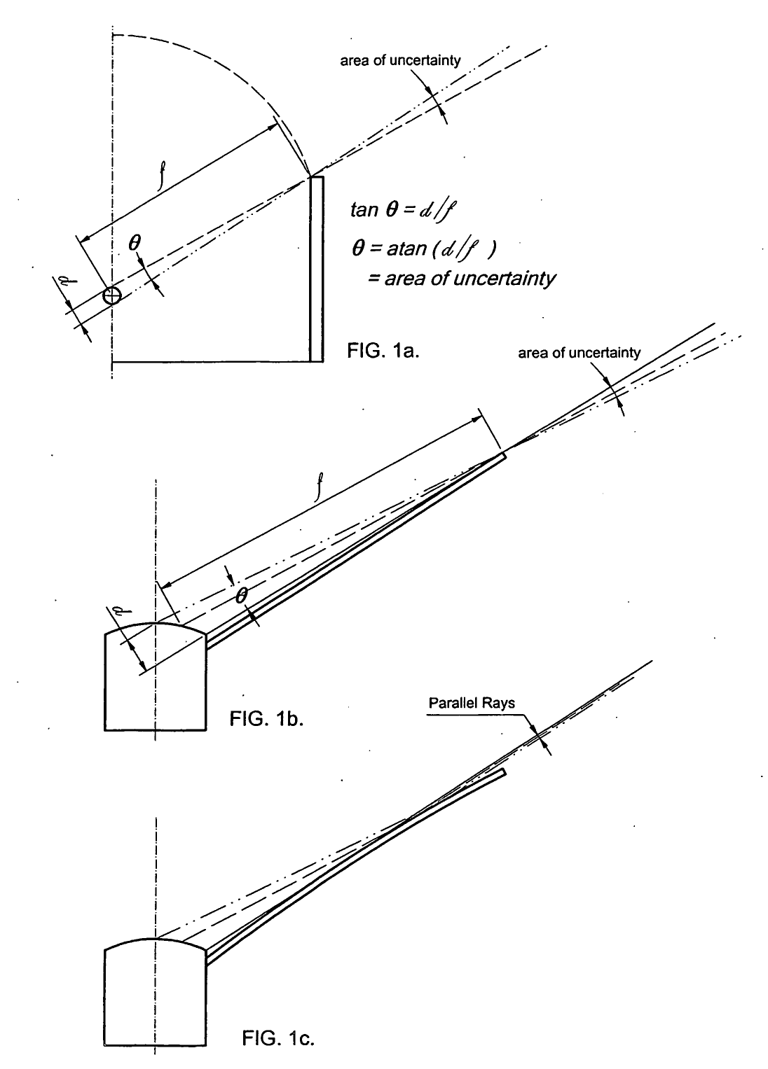

The regulations state that side lights must have an “arc of visibility” of 112.5 degrees (lateral) taken from a bow (straight ahead) reference (see FIG. 1). Stem lights have an “arc of visibility” of 135 degrees whilst masthead lights have an “arc of visibility” of 225 degrees. The sector boundaries (visible/not visible transition) will be referred to throughout the rest of the specification as a “cut off”. A sharp sector boundary cut-off (that is, visible to not visible) is seen as extremely desirable.

However, in practice the cut off is seldom sharp.

Referring to FIG. 1a of the drawings, at the sector boundary location, there is an “area of uncertainty”. Accordingly, the boundary change from visible to not visible actually occurs over a few degrees. This effect is gradually greatly exaggerated in FIG. 1a. The effect is due to the fact that the light source has a width dimension. As an observer moves across the sector boundary of the arc of visibility one edge of the light source will be unmasked before the other edge and the light intensity will appear to gradually increase or decrease to the observer not dissimilar to that observed by a rising or setting sun. This effect can be mathematically calculated where d=the diameter of the light source, f=the distance in metres from the light source to the edge of the mask.

### PRIOR ART LIGHTS

Prior art sidelights usually comprise a metal or plastics casing which is adapted to enable it to be affixed to the (usually) upper deck structure of a vessel. Mounted within the casing is an incandescent bulb often referred to as a “festoon” bulb. This type of bulb has an elongated filament and it is mounted with an orientation such that when the sidelight is mounted the filament is vertically aligned. It is much easier to configure a desirable optical result utilising a long thin filament. These lights typically include various combinations of mirrors, masks, and internal/external prismatic front lenses to achieve the requisite “arc of visibility”.

There are undesirable characteristics associated with these lights.

Firstly, because these lights need to be visible for considerable distance across their full “arc of visibility” (for example, 2 nautical miles for vessels up to 20 meters), they require the use of a comparatively high wattage incandescent bulb, typically in the range of 10-25 watts. This is seen as undesirable because power drain can sometimes be a problem for vessels, particularly smaller craft.

Secondly, incandescent bulbs utilising a tungsten filament are particularly susceptible to distortion or even complete failure from impact shock or continual vibration.

Thirdly, the brightness of incandescent bulbs steadily degrades and they have a comparatively short life in hours under marine conditions.

Fourthly, currently available lights tend to be conducive to high scattered light levels.

Alternative illumination devices are now available, particularly the new generation of “ultra bright” LEDs. These are now available in a range of colours including red, green and white.

LEDs have several advantages over incandescent bulbs.

Ultra bright LEDs produce an intense light and require only a fraction of the power in comparison to an incandescent bulb of a similar light output.

LEDs are not affected by vibration.

LEDs have a particularly long life (up to 100,000 hours if properly managed).

To date, these LED devices have not been utilised in a light of this type because it has not been practical to design and manufacture a light to meet the strict illumination, cut-off and scattered light properties set down by the regulations.

### AIM OF THE INVENTION

The aim of the invention is to provide a sectored light that preferably utilises the use of LEDs as a light source (although a conventional incandescent bulb may still be utilised) and goes toward solving the above mentioned problems.

According to a first broad aspect the invention provides a sectored light comprising:
a casing including a base portion and a light transmitting portion,
a light source comprising at least one LED;
a lens element to collect and disperse the light emitted by the source;
a reflective element associated with each side of the lens;
said reflective element having a reflective surface that is positively curved in lateral cross-section.

In a preferred embodiment, the light source, the lens element, and the reflective elements are mounted in position on said base portion; and wherein the said base portion is sealed to the balance of the casing such that the components are enveloped within.

Expediently, the base portion includes an circuit board containing requisite electronic circuits and components necessary to control the light output.

In one embodiment, the light source comprises six LED devices arranged in longitudinal alignment, and the lens element further comprises an elongate body having a top light projecting surface, and a bottom light receiving surface, a longitudinal groove along the bottom light receiving surface and a toric lens associated with each LED device formed into the top light projecting surface. Preferably, the longitudinal groove is semi-circular in cross-section.

The circuit board includes a light intensity regulation circuit including at least one light intensity sensor to measure light output from the LED devices, and preferably a second sensor shielded from said LED devices to measure ambient light intensity.

In the preferred embodiment, the casing is retained in a holder adapted to be affixed to a marine vessel.

According to a second broad aspect the invention provides a sectored light comprising:
a casing including a base portion and a light transmitting portion,
a light source comprising at least one incandescent bulb;
a lens element to collect and disperse the light emitted by the source;
a reflective element associated with each side of the lens;
said reflective element having a reflective surface that is positively curved in lateral cross-section.

### DETAILED DESCRIPTION OF A PREFERRED EMBODIMENT OF THE INVENTION

In further describing the invention, reference is made to the accompanying drawings in which:

FIG. 1 depicts the arcs of visibility for sectored lights;

FIG. 1a depicts the area of uncertainty for a conventional sectored light;

FIG. 1b and c are views similar to FIG. 1 for the sectored light according to the invention;

FIG. 2 depicts a view of a sidelight according to the invention shown in exploded perspective view;

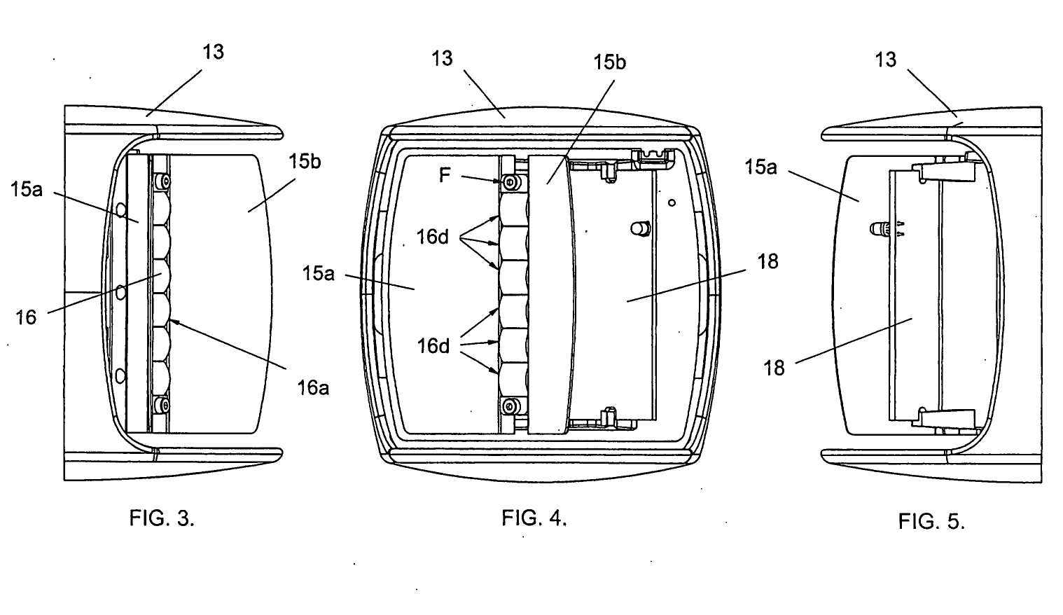

FIG. 3 is a side elevation;

FIG. 4 is a front elevation;

FIG. 5 is the other side elevation;

FIG. 6 is a perspective view; and

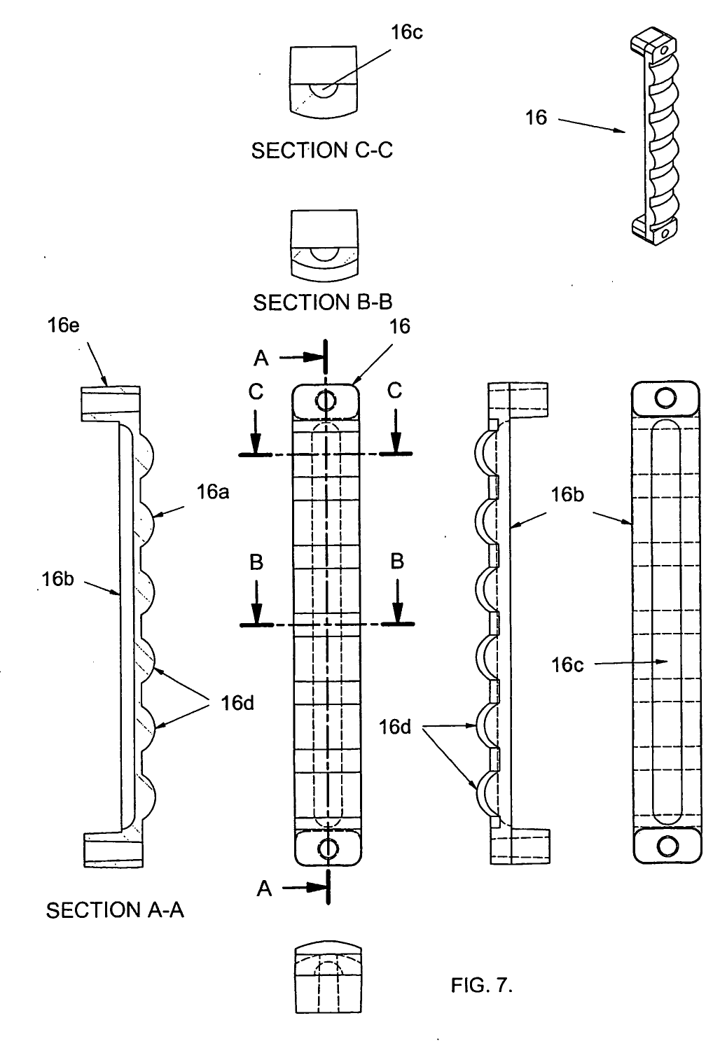

FIG. 7 is a lens element shown from different perspectives.

Referring to the drawings, the sectored light shown is a sidelight 10 and comprises a waterproof casing containing the working components together with a holder 13 which is a fixable to the topsides or hull a vessel.

The waterproof casing is formed from two components. The first of these components is a light transmitting clear or clear coloured plastics (acrylic) housing 11. The housing is substantially semi-circular in lateral cross-section and has flat top and bottom portions and an open back as shown. The housing is slightly wider at its waist region but could equally be straight-sided. In the case of a port sidelight, the housing would be red in colour and conversely green in the case of a starboard sidelight. Alternatively, the casing could be clear if coloured LEDs devices are utilised or the light is intended to be used as a stem or mast light. The face portion 11a has no optical correction.

The second component comprises a base portion 12 of the complimentary size and shape to the open back of the housing. The base portion 12 mounts the working components of the light as will shortly be described and includes an aperture through which a power cord may pass. The base together with the working components is mated to the opening in the housing and sealed in place. To facilitate this, the housing may include locating lips or recesses to ensure that the base is correctly located.

The working components of the light comprise a circuit board 13; an LED block (six devices) 14; two reflective elements 15a, 15b; and an elongate lens element 16.

The circuit board 13 contains the necessary electronic circuits regulate input voltage (usually from nominal 9 to 36 volt systems) to drive the LED devices at their required ratings. These devices will only achieve their maximum life if driven at the correct forward voltage/current combination. A typical LED device should be driven at a forward voltage of about 1.8-4 at the designed current. The light output of the devices takes into account both voltage and temperature. Additionally, the light output may vary with age. The circuit board contains compensatory circuits to counter these effects and stabilise light output.

To this end, an important aspect of this invention is the inclusion of light intensity sensors at locations along the LED block. The light intensity sensors along the LED block are used to control the LED devices according to “light output” during night-time conditions. As these sensors will also be affected by ambient light which will distort the readings, a further sensor is located at a position where it is exposed to ambient light whilst not exposed to light output from the LED devices. A suitable position is behind reflective element 15b. During change of light conditions such as night to daybreak, the further sensor will detect this ambient light and switch the circuits to “current control”, that is where the LED devices are controlled by a current management alone to ensure that light output is still maintained during the transition period from night to daylight or vice versa.

The LED block 14 plugs into a suitable socket in the circuit board and the elongate lens element 16 fits over the LED block 14.

An individual LED device emits an essentially conical beam of light with about a 100 degree spread. It will be appreciated that this is insufficient to be seen across an arc of 112.5 degrees.

Accordingly, some form of lens is necessary to laterally diverge the light spread to the requisite 112.5 degrees, and to a lesser extent to diverge the light vertically depending on the spacing between the individual LED devices.

The lens element 16 achieves this and is preferably made of acrylic (which does not yellow with age). The lens comprises an elongate body having a top light projecting surface 16a, a bottom light receiving surface 16b, a longitudinal groove 16c along the bottom light receiving surface and a toric lens 16d associated with each LED formed into the top light projecting surface. Preferably, the longitudinal groove 16c is semi-circular in cross-section. Alternatively, a number of individual lenses could be mounted one above the other.

The optical lenses of the LED devices are located in the semi-circular groove which also helps, together with the vertical divergence provided by the toric lenses to spread the light into a continuous beam along the full length and width of the lens. The lenses ensure that the light spread is relatively uniform across the full viewing width and vertical height to comply with energy distribution standards. The power of the toric lenses may be varied depending on the use of the particular light. For example, lights to be utilised on a yacht require a different vertical light spread distribution than lights on equivalent sized powered vessels.

The lens element 16 includes a leg 16e at each end to enable it to be affixed to the circuit board preferably by means of small threaded fasteners F.

The reflective elements 15a and 15b are identical and interchangeable. They comprise elongate metal elements, expediently of aluminium. It would be possible to manufacture these items as a single piece, however, it is more practical to separate them into two portions.

Each reflective element includes a polished reflecting surface 15c and a right-angled bracket portion 15d by which it is affixed to the circuit board hard up against the longitudinal side face of the elongate lens element 16 such that the toric lenses of element 16 project above the polished reflecting surface 15c. The elements also serve as a useful heat sink to take heat away from the LED devices. The reflective elements 15 when mounted diverge at an angle of substantially 112.5 degrees (in the case of a side light) or 135 degrees (in the case of a stern light) or 225 degrees (in the case of a mast light).

The reflecting surface 15c is specially shaped. It is of a length such that it is longer than the elongate lens element 16 and projects equidistant beyond each end thereof It has no curve in its longitudinal dimension but has a small positively curved dimension to the lateral dimension of the reflecting surface. The extent of this curve is dependent on the particular reflective element/lens configuration. The relationship between the top surface of the lens element 16 and the reflecting surface 15c is critical. The top surface 16a must project above the reflecting surface of the mirror only to the extent of the transition between the straight side and the curved top surface 16a.

Referring firstly to FIG. 1b, it can be seen how a lens and planar reflecting surface combination will substantially maintain the “area of uncertainty”. Referring to FIG. 1c, it can be seen how the lens/curved reflecting surface combination of the present invention substantially reduces/eliminates the “area of uncertainty”. Light rays emerging from any point along the relevant side of the curved toric lens surface are reflected by the curved reflecting surface into substantially parallel rays at the sector boundary

As an observer crosses the sector boundary the first ray of light R becomes visible. The lens 16 in combination with the curved reflecting surface ensures that light intensity rapidly intensifies over a much narrower transition than prior art devices. The curvature of the reflecting surfaces ensures that no light rays can be seen beyond the extent depicted in FIG. 1c.

Referring to FIG. 1, the requisite arc of visibility for a side light is 112.5 degrees. It will be appreciated that because the housing 11 is substantially semi-circular in cross-section the default arc of visibility would accordingly be 180 degrees. The arc of visibility is more or less defined by the angle between the reflective elements 15. Accordingly, to ensure that the arc of visibility commences substantially from one edge portion of the housing 11 (see FIG. 6), it is necessary to cant the components to the appropriate degree.

This is expediently achieved in the following manner. Referring to FIG. 2 of the drawings, a portion of the base 12 is inclined at 12a (approximately 68 degrees). The circuit board 13 (to which the components are mounted) is affixed to the ramp. Optionally further retaining arms 12b clip over the board to stabilise the same.

In the case of mast or stern lights, because these are mounted on the front or back of the vessel, the components can be mounted centrally within the casing. Alternatively, a mast light could comprise two side lights joined together into a single unit.

Similarly, two sidelights (port/starboard colours) as described could be joined together into a single unit.

It will be appreciated that the above description is by way of example only and the device may be modified in many ways without departing from the scope of the invention. For example, the performance of a sectored light utilising an incandescent bulb could be markedly improved by utilising and configuration according to the second aspect of the invention.

1. A sectored light comprising:
a casing including a base portion and a light transmitting portion,
a light source comprising at least one LED;
a lens element to collect and disperse the light emitted by the source;
a reflective element associated with each side of the lens; said reflective element having a reflective surface that is positively curved in lateral cross-section.

2. A sectored light according to claim 2, wherein the reflective elements are made of metal, one surface of which is polished to form said reflective surface.

3. A sectored light according to claim 1 wherein the reflective elements diverge outwardly from the sides of said lens element.

4. A sectored light according to claim 3 wherein the angle of divergence is substantially 112.5 or 135 degrees.

5. A sectored light according to claim 1 wherein the reflective elements are elongate, and the reflective surfaces have no curve in their longitudinal dimension and a small positive curve in their lateral cross-section.

6. A sectored light according to claim 1 wherein the reflective elements are made of aluminium.

7. A sectored light according to claim 1 wherein the lens element further comprises an elongate body having a top light projecting surface, and a bottom light receiving surface, a longitudinal groove along the bottom light receiving surface and a toric lens associated with each LED device formed into the top light projecting surface.

8. A sectored light according to claim 7, wherein the longitudinal groove is semi-circular in lateral cross-section.

9. A sectored light according to claim 7 wherein the top light projecting surface projects slightly above the leading edge of the reflective surfaces adjacent each side of the lens element.

10. A sectored light according to claim 9 wherein light rays emerging from any point along the relevant side of the top light projecting surface are reflected by the curved reflecting surface into substantially parallel rays at the sector boundary.

11. A sectored light according to claim 1, wherein the light source comprises six LED devices arranged in longitudinal alignment.

12. A sectored light according to claim 1, wherein the base portion includes a circuit board containing requisite electronic circuits and components necessary to control the light output.

13. A sectored light according to claim 12, wherein the circuit board includes a light intensity regulation circuit including at least one light intensity sensor to measure light output from the LED devices.

14. A sectored light according to claim 13 wherein a second sensor shielded from said LED devices to measure ambient light intensity.

15. A sectored light according to claim 1, wherein the light source, the lens element, and the reflective elements are mounted in position on said base portion; and wherein the said base portion is sealed to the light transmitting portion of the casing such that the components are enveloped within.

16. A sectored light according to claim 15, wherein the surface that mounts the light source, the lens element, and the reflective elements is inclined with respect to the base.

17. A sectored light according to claim 16, wherein the angle of inclination is approximately 68 degrees.

18. A sectored light according to claim 1, wherein the casing is retained in a holder adapted to be affixed to a marine vessel.

19. A sectored light comprising:
a casing including a base portion and a light transmitting portion, a light source comprising at least one incandescent bulb;
a lens element to collect and disperse the light emitted by the source;
a reflective element associated with each side of the lens; said reflective element having a reflective surface that is positively curved in lateral cross-section.
